(19) United States
(12) Patent Application Publication
(10) Pub. No.: US 2016/0300130 A1
(43) Pub. Date: Oct. 13, 2016

(54) COLOR TRANSFORMATION

(71) Applicant: HEWLETT-PACKARD DEVELOPMENT COMPANY, L.P., Houston, TX (US)

(72) Inventors: Marti Rius Rossell, Sant Cugat del Valles (ES); Jan Morovic, Colchester (GB); Peter Morovic, Sant Cugat del Valles (ES)

(73) Assignee: Hewlett-Packard Development Company, L.P., Houston, TX (US)

(21) Appl. No.: 15/028,877

(22) PCT Filed: Oct. 15, 2013
(86) PCT No.: PCT/EP2013/071564

§ 371 Date: Apr. 12, 2016

(51) Int. Cl. G06K 15/02; H04N 1/60

(52) U.S. Cl. CPC G06K 15/1878; H04N 1/6019; H04N 1/6066; G06K 2215/0094

(57) ABSTRACT

An example method of transforming colors for a printing device in accordance with the present disclosure is provided. The color printing device comprises a plurality of printing element, each printing element having an element gamut, represented in 3-D space associated therewith. The method comprises defining a first gamut volume in a 3-D space for the printing device, and transforming the defined first gamut volume into the element gamut to create a second gamut volume in 3-D space for the printing device.

### BACKGROUND

Color image processing to convert an image into a printable image, that is an image capable of being printed, invariably involves some form of color and data transformation to convert the pixels of the color image into a printable image comprising a plurality of printable pixels, that is a pixel capable of being printed, defined by the colors of the printing device.

This conversion may be achieved by use of a lookup table to map the colors of the image into the colors of the printable image. In order to achieve accurate conversion and consistency between printing elements (such for example printheads or elements of a printhead) of the printing device, the colors printable by the printing device are calibrated and the lookup table is populated based on the calibration.

### BRIEF DESCRIPTION OF THE DRAWINGS

For a more complete understanding, reference is now made to the following description taken in conjunction with the accompanying drawings in which:

FIG. 1 is a simplified schematic diagram of a color printing system according to an example;

FIG. 2 is a simplified schematic diagram of an apparatus for calibrating a printing device according to an example;

FIG. 3 is a flowchart of a method of calibrating a color printing device of an example;

FIG. 4 is a flowchart of a method of calibrating a color printing device of FIG. 3 in more detail;

FIG. 5 illustrates an example of defining a first gamut volume;

FIGS. 6, 7a and 7b illustrate a representation of an example of creating the transformation function;

FIG. 8 is an example of a first gamut of the printing elements;

FIGS. 9a and 9b are examples of creating the transformation with a point outside of the gamut volume; and

### DETAILED DESCRIPTION

In printing system, such as for example, a Page-Wide Array (PWA) printing system having a plurality of neighbouring printing elements which print across the media in bands, any differences in the colors generated by each printing element may become visible to the human eye as the colors are adjacent in bands making any difference, however slight, noticeable. Therefore, such printing systems impose very low color difference thresholds. As a result a more accurate color transform is required.

Prior solutions in the industry attempt to define the color transform through a general function not bounded by spatial constraints, such as a polynomial or a biharmonic operator. Such approaches lead to successful interpolations on those points that lie within the mesh of the transformation-defining points. However, the transformation of points outside the transformation domain is merely driven by the extrapolation of the behavior in the interior. The problem is that such extrapolation is likely to rapidly diverge and to provide non-accurate positioning of point in the destination space.

One type of prior solution to this is the usage of a tessellation to perform the transformation. However, it is unclear how the tessellation is defined (and furthermore there are no references on whether a gamut boundary is explicitly defined), and also there appears to be no solution of transforming the points outside of the hull.

Another solution for obtaining a highly detailed gamut description is obviously printing and measuring a large number of patches. The drawback is the large number of media real state and measurement times required to get a certain level of accuracy, which makes the method unfeasible for PWA printing systems.

The challenge comes when such accurate calibration is to be done on a reduced set of calibration patches, so that the procedure minimizes time and media waste. Note that, for a PWA printer, each die (or, in some cases, each die portion) counts as an independent printer to be calibrated. This fact multiplies the number of patches to be printed and measured.

Further, the use of a tessellation to perform the transformation can not be used to transform the points outside of the hull as there appears to be no explicit definition of the gamut boundary.

Another solution for obtaining a highly detailed gamut description is obviously printing and measuring a large number of patches. The drawback is the large number of media real state and measurement times required to get a certain level of accuracy, which makes the method unfeasible for PWA printers.

It is assumed that the gamuts of the printing systems (or dies) under consideration are similar in shape. This assumption is also made by existing one-dimensional, per-ink solutions.

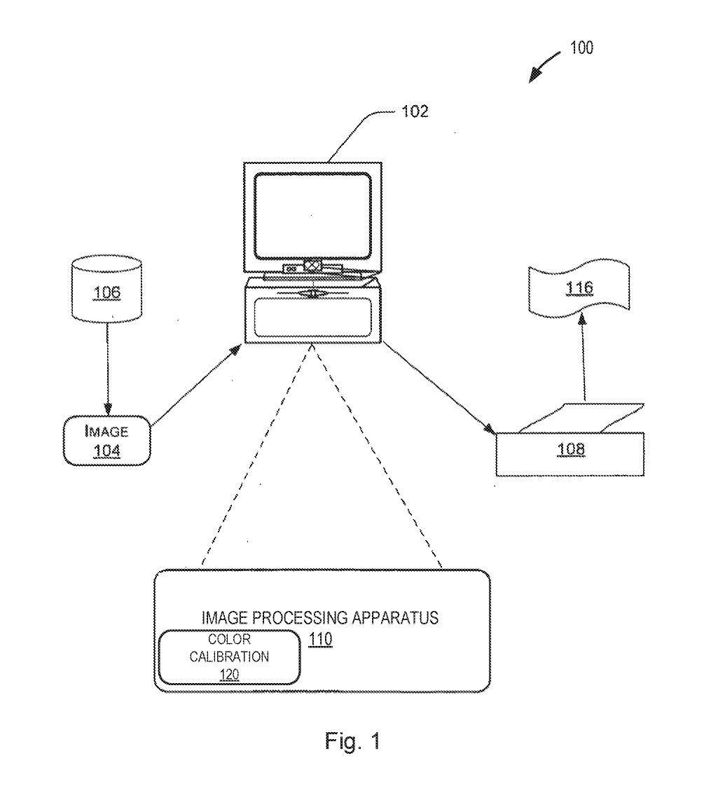

FIG. 1 illustrates an example of a printing system 100 including image processing apparatus 110. Printing system 100 can be implemented, at least in part, by one or more suitable computing devices, such as computing device 102. Other computing devices that may be used include, but are not limited to, a personal computer, a laptop computer, a desktop computer, a digital camera, a personal digital assistance device, a cellular phone, a video player, and other types of image sources.

In one implementation, an image 104 is uploaded to the computing device 102 using input device 108. In other implementations, the image may be retrieved from a previously generated image set contained on a storage media, or retrieved from a remote storage location, such as an online application, using the Internet. Image 104 may be a still digital image created by a digital camera, a scanner, or the like. In other implementations the image may be a moving image such as a digital video. Image 104 may be sent to an output device such as printing device 108 by the computing device 102. Other printing devices that may be used include, but are not limited to, a dot-matrix printer, an inkjet printer, a laser printer, line printer, a solid ink printer, and any other kind of digital printer. In other implementations, the image may be displayed to a user on an output device 108 including, but not limited to, a TV set of various technologies (Cathode Ray Tube, Liquid Crystal Display, plasma), a computer display, a mobile phone display, a video projector, a multicolor Light Emitting Diode display, and the like. The printing device 108 comprises a plurality of printing elements, for example, multiple arrays of ink nozzles for depositing ink onto a printing media 116.

In one implementation, the printing system 100 comprises image processing apparatus 110. The image processing apparatus 110 may be integral with the computing device 102 or the printing device 108. The image processing apparatus 110 includes a color calibration apparatus 120.

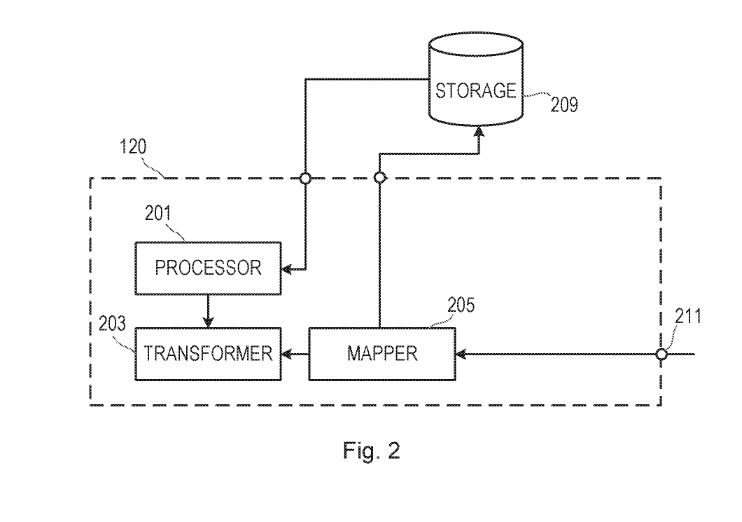

The color calibration apparatus 120 for calibrating the plurality of printing elements of the printing device 108 is shown in FIG. 2. It comprises a processor 201 connected to a storage device 209. The storage device 209 may be integral with the calibration apparatus 120, or external thereto. The color calibration apparatus 120 further comprises a transformer 203 connected to the processor 201 and a mapper 205. The mapper 205 also accesses the storage device 209. The mapper 205 provides an output on the output terminal 211 of the color calibration apparatus 120.

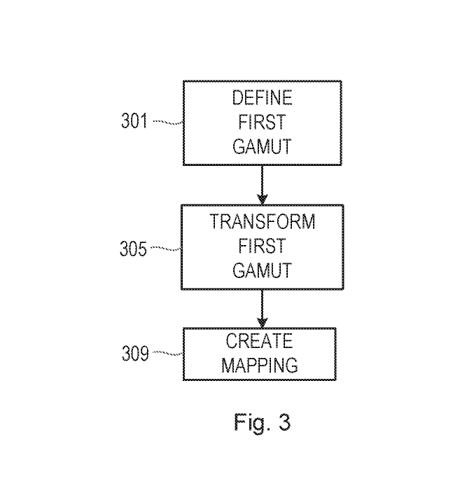

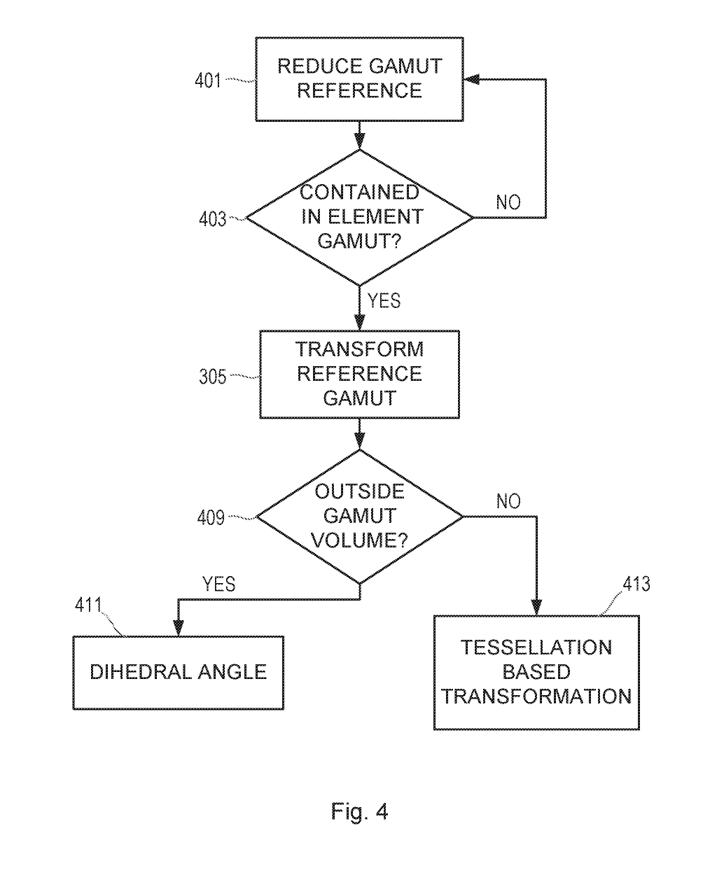

Operation of the color calibration apparatus 120 is described with reference to FIGS. 3 to 9b. The processor 201 defines, 301, a first gamut volume in 3-D space to which all printer elements are calibrated. The first gamut is included in the intersection of all the gamuts (so that all colors provided by the printing elements are calibrated). Therefore, the smallest gamut in the printer (the lightest die) determines the gamut of the whole system.

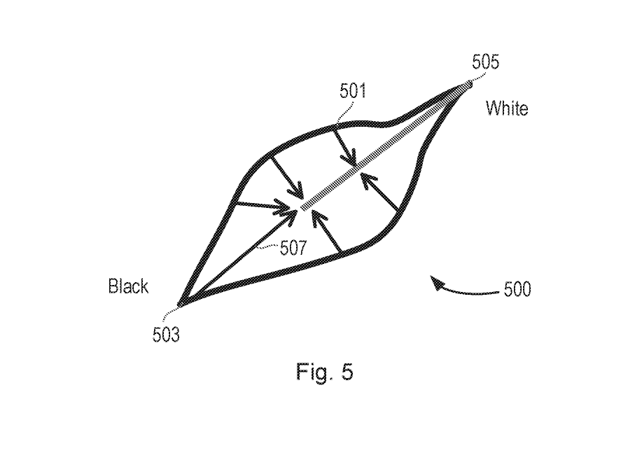

First, a reference gamut is retrieved from the storage device 209 by the processor 201. This may be an arbitrary gamut 500 (as illustrated in FIG. 5) described in high detail (in the order of 9³=729 patches or more) having a first extreme point 503 near “black” and a second extreme point 505 near “white”. The reference gamut 500 is then defined by the boundary 501 between the first and second extreme points 503, 505. The reference gamut may be obtained at development time. The fundamental idea is that this gamut shape (not its exact position and size) adequately represents the gamut of any of the plurality of printer elements. The reference gamut 500 is then iteratively reduced, 401, 403 until fully contained in the smallest of the element gamuts of the printer elements to be calibrated. The element gamut describes the gamut of the elements in a lower level of detail, in the order of 5³=125 patches. This gamut is also retrieved by the processor 201 from the storage device 209. Alternatively, a printing device may consist of 3 printing elements with gamuts of similar volume, but of different shapes, for example, the first of them could have the smallest gamut in the Reds, the second one in the greens and the last one in the blues. Then, the reference gamut would be contained in all of them.

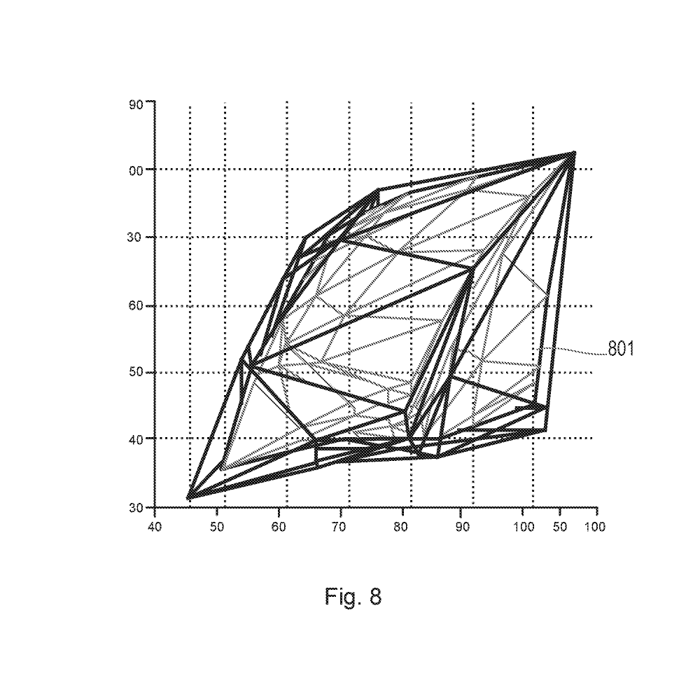

Reduction of the reference gamut 500 is achieved by projecting each point to a semi segment that goes from white to a medium gray as illustrated by the arrows 507 shown in FIG. 5. The first gamut 801 obtained is depicted in FIG. 8.

The process of build a highly detailed description of the printing device 108 to calibrate involves a transformation 305 of the highly-detailed reference gamut so that it coincides with the element gamut points location.

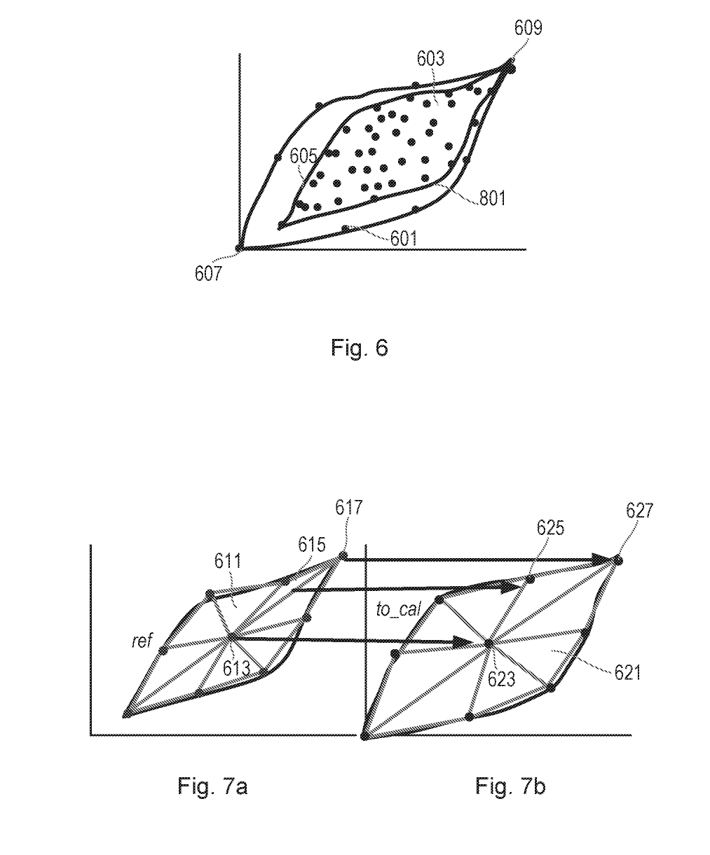

The transformation function maps the first gamut volume into the element volume, using the few element gamut calibration points as anchors. A resulting second gamut volume is obtained as shown in FIG. 6. The element gamut volume is defined by the boundary 601 between a first extreme point 607 near “black” and a second extreme point 609 near “white”. The second extreme point of the first gamut volume 500 defined by the boundary 501 is aligned with the second extreme point 609 of the second extreme point 609 of the element gamut 601.

The transformation input space 611 of the first gamut volume 801 is divided in a regular tetrahedral grid as illustrated in FIG. 7a that maps to another grid 621 in the output space of the element gamut 601 to be calibrated. A plurality of anchor points 613, 615, 617 in the transformation input space 611 form anchor points for the transformation function to transform to the points 623, 615, 627 of the transformation output space. The transformation function explicitly defines a boundary between the interior and the exterior of the transformation hull by the second gamut volume. A mapping for all colors can then be created, 309.

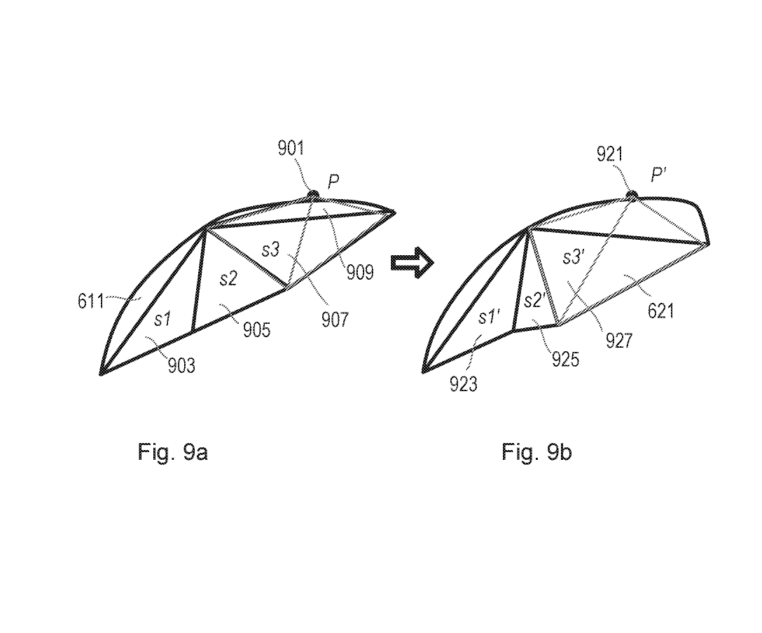

For points inside the second gamut volume, 409, a tessellation-based transform is used, 413. For points outside of the second gamut volume, as shown in FIGS. 9a and 9b, the relative position of an outlier point p 901 in the transformation input space 611 is determined according to the dihedral angle 909 it projects to each of the visible gamut faces 411. Therefore, p 901 can be described as a set of weights, barycentric coordinates and indices to visible simplices 903, 905, 907. The transformation of point p 901 to the point of p¹, 921 in the second gamut volume is determined by weighting barycentric coordinates with dihedral angles for each of the simplices 923,225,927 in the transformation output space 921 as shown in FIG. 9b.

As a result the transformation function explicitly defines a boundary between the interior and the exterior of the transformation hull, and that different methods are used to transform points in each of the domains to create the mappings. The transformation methods of tessellation-based interpolation or the dihedral-angle based extrapolation are merely examples and it can be appreciated that other techniques may be used as alternatives.

The transformation function that creates second gamut volume is then used to create the mapping 309 between the actual colors and those printed by the printing elements. This mapping may be stored as a look-up-table (LUT) or the like.

This may be achieved by tessellating the second gamut volume and interpolating the position of the actions color within the second gamut volume tessellation to obtain the mapping to store in an LUT.

The result brings the gamut of a printing device to be calibrated as close as possible to the gamut of a “reference” printing device. The solution is commonly named 3D because it prints and measures points across the whole gamut space (which is three-dimensional, as opposed to Closed Loop Calibration (CLC) which does so only on primary colors in the ink space, which is one-dimensional).

Points forming a color gamut are transformed according to a transformation function providing significant improvements in accuracy while reducing the number of required calibration patches.

The fact that the method explicitly defines the boundary between the interior and exterior of the transformation hull allows the selection of the most convenient method for each region. The points outside the transformation hull are transformed with similar accuracy as the ones in the interior providing a method close to optimal.

A further benefit of the method is that it delivers a map of a given state of a printer/die onto a reference instead of being only an approximate, unbounded color space transformation. This results in greater gamut preservation and greater accuracy too.

Although various examples have been illustrated in the accompanying drawings and described in the foregoing detailed description, it will be understood that the present disclosure is not limited to the examples disclosed, but is capable of numerous modifications without departing from the scope of the present disclosure as set out in the following claims.

What is claimed is:

1. A method of transforming colors for a printing device, the printing device comprising a plurality of printing elements, each printing element having an element gamut, represented in 3-D space, associated therewith, the method comprising:
defining a first gamut volume in a 3-D space for the printing device; and
transforming the defined first gamut volume into the element gamut to create a second gamut volume in 3-D space for the printing device.

2. The method as recited in claim 1, wherein defining the first gamut volume further comprises:
iteratively reducing a reference gamut of the printing device until the reference gamut is fully contained within the 3-D space of the element gamut having the smallest volume.

3. The method as recited in claim 2, wherein iteratively reducing the reference gamut further comprises:
projecting each point within the reference gamut to a semi segment that goes from white to gray.

4. The method as recited in claim 1, wherein transforming the defined first gamut volume further comprises:
creating a transformation function to map the first gamut volume forming a first transformation input space into the element gamut forming a second transformation output space, wherein a predetermined number of points within the first gamut volume form anchor points for the transformation function.

5. The method as recited in claim 4, wherein creating the transformation function further comprises:
dividing the first transformation input space into a regular tetrahedral grid to map to another grid in the second transformation space.

6. The method as recited in claim 5, wherein creating the transformation function further comprises;
transforming points located within the second gamut volume by a tessellation-based transformation.

7. The method as recited in claim 6, wherein creating the transformation function comprises;
transformation points located outside the second gamut volume according to the dihedral angle the transformation points projects to each of the faces of the second gamut volume.

8. An apparatus for transforming colors for a printing device, the printing device to receive a plurality of printing elements, each printing element having an element gamut, represented in 3-D space, associated therewith, the apparatus comprising:
a processor to define a first gamut volume in 3-D space for each printing element; and
a transformer to transform a reference gamut into each defined first gamut volume to create a second gamut volume in 3-D space for each printing element.

9. A color printing device for printing an image, the printing device to receive a plurality of printing elements, each printing element having an element gamut represented in 3-D space associated therewith, the color printing device further comprising calibration apparatus, the calibration apparatus comprising:
a processor to define a first gamut volume in 3-D space for each printing element;
a transformer to transform a reference gamut into each defined first gamut volume to create a second gamut volume in 3-D space for each printing element;
a measuring module to measure actual colorimetry of a predetermined set of colors produced by each printing element; and
a mapper to create a mapping of the actual colorimetry of the predetermined set of colors produced by each printing element and the corresponding color within the second gamut volume to calibrate the color printing device.
